(19) United States
(12) Patent Application Publication
(10) Pub. No.: US 2003/0076291 A1
(43) Pub. Date: Apr. 24, 2003

(54) Flat display with suspension device for use in a vehicle

(76) Inventor: Hsi Kuang Ma, Taipei (TW)

Correspondence Address: JOHNSON & ASSOCIATES, P.C., 14625 Baltimore Avenue #282, Laurel, MD, 20707, US

(21) Appl. No.: 10/025,626

(22) Filed: Dec. 26, 2001

(30) Foreign Application Priority Data
Oct. 24, 2001 (TW) 090218185

(51) Int. Cl. G09G 5/00

(52) U.S. Cl. 345/156

(57) ABSTRACT

A flat display with suspension device for use in a vehicle includes a display body having circuits connected to a playback module and a display screen for displaying images, at least one suspension strip having one end connected to the display body and the other end connected to a suspension plate, the suspension plate being provided with two suspension holes which are spaced apart by a distance adapted to correspond to that between two suspension hooks of a sunshield of the vehicle.

### BACKGROUND OF THE INVENTION

1. Field of the Invention

The present invention relates to a flat display with a suspension device which can be conveniently suspended and secured in a vehicle.

2. Description of Related Art

Flat displays do not occupy a large amount of space and are therefore often used in places where available space is limited, for instance, in a vehicle, for displaying images.

A common way of mounting a flat display in a car is by securing the flat display to the control panel in front of the driver's seat. However, this would need to damage the control panel. At the same time, the flat display cannot be taken out of the car when desired. If a replacement mount is installed for securing the flat display, it would be costly and occupy a lot of the space available on the control panel.

### SUMMARY OF THE INVENTION

Therefore, the primary object of the present invention is to provide a flat display with a suspension device for use in a vehicle so as to overcome the drawbacks associated with the prior art.

### BRIEF DESCRIPTION OF THE DRAWINGS

The foregoing and other features and advantages of the present invention will be more clearly understood from the following detailed description and the accompanying drawings, in which,

FIG. 1 is a perspective view of the present invention;

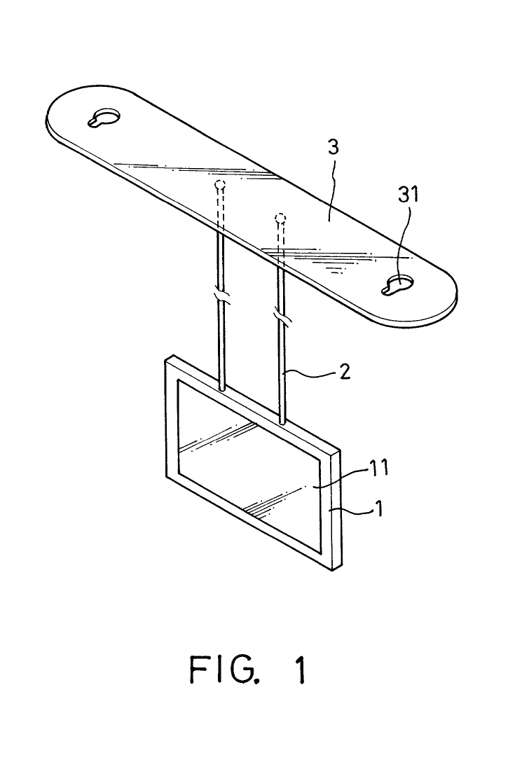

FIG. 2 is a schematic view illustrating installation of the present invention; and

FIG. 3 is a schematic view illustrating the present invention when mounted in a car.

### DETAILED DESCRIPTION OF THE PREFERRED EMBODIMENTS

As shown in the drawings, the display according to the invention essentially includes a display body 1, at least one suspension strip 2 and a suspension plate 3.

The display body 1 has a known construction, and is a flat display having a display screen 11 for output of images.

The suspension strip 2 is an elongate strip having one end fixed to the display panel 1. The other end of the suspension strip 2 can be fixed directly to the suspension plate 3 or can be first coupled with a connector and then connected to the suspension plate 3. Furthermore, the suspension strip 2 can be configured to be retractable. The retractable mechanism can be achieved by means of interconnected inner and outer tubes, which can be so arranged as to permit stage positioning. As such is known in the art, a detailed description thereof is not provided herein for the sake of brevity.

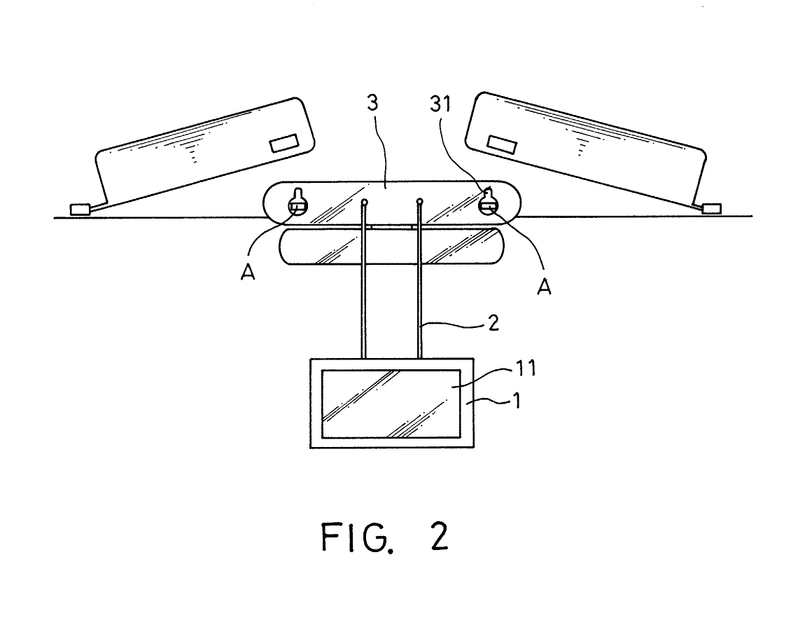

The suspension plate 3 is connected to the other end of the suspension strip 2. The suspension plate 3 has two lateral sides provided with suspension holes 31 adapted to engage suspension hooks (A) of a sunshield of a car. The distance between the suspension holes 31 should correspond to that between the suspension hooks (A) so that the suspension plate 3 can be secured by means of the suspension hooks (A), as shown in FIG. 2.

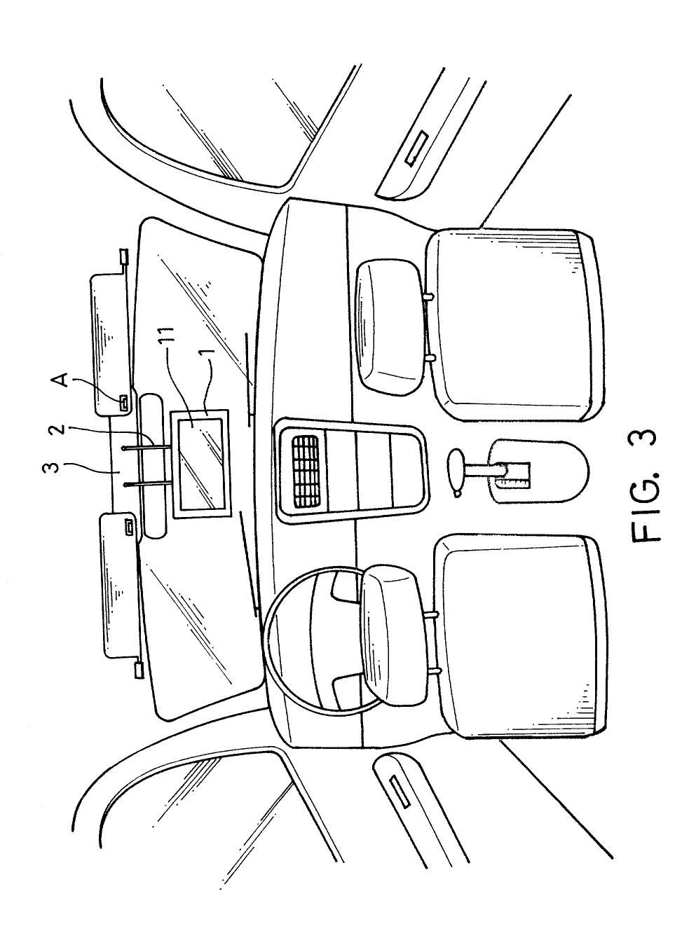

Referring to FIG. 3, after installing the present invention in the car, the flat display will be located just in front of the driver's seat and below the rear view mirror, in an elevatable state. Hence, the driver can view the flat display from an angle substantially the same as that when habitually looking at the rear view mirror.

In view of the aforesaid, by virtue of the present invention, the flat display can be suspended and secured in a vehicle at a suitable position, which is not achievable by the prior art.

Although the present invention has been illustrated and described with reference to the preferred embodiment thereof, it should be understood that it is in no way limited to the details of such embodiment but is capable of numerous modifications within the scope of the appended claims.

What is claimed is:

1. A flat display with suspension device for use in a vehicle, comprising:
a display body having circuits connected to a playback module and a display screen for displaying images;
at least one suspension strip having one end connected to said display body and the other end connected to said suspension plate; and
a suspension plate being provided with two suspension holes that are spaced apart by a distance that is adapted to correspond to a distance between two suspension hooks of a sunshield of the car such that said suspension holes can engage the suspension hooks to thereby dispose said display screen below a rear view mirror.

2. The flat display with suspension device for use in a vehicle as claimed in claim 1, wherein said suspension strip and said display are connected in a fixed manner.

3. The flat display with suspension device for use in a vehicle as claimed in claim 1, wherein said suspension strip and said suspension plate are connected in a fixed manner.

4. The flat display with suspension device for use in a vehicle as claimed in claim 1, wherein said suspension strip is retractable.

5. The flat display with suspension device for use in a vehicle as claimed in claim 1,wherein said suspension strip includes two strip units.

6. The flat display with suspension device for use in a vehicle as claimed in claim l,wherein said suspension strip is connected to a connector and is further connected to said suspension plate.
